(19) United States
(12) Patent Application Publication
(10) Pub. No.: US 2013/0179531 A1
(43) Pub. Date: Jul. 11, 2013

(54) NETWORK COMMUNICATIONS APPARATUS, METHOD, AND MEDIUM

(71) Applicants: Daisuke Sakai, Tokyo (JP); Ryosuke Mizunashi, Kanagawa (JP)

(72) Inventors: Daisuke Sakai, Tokyo (JP); Ryosuke Mizunashi, Kanagawa (JP)

(21) Appl. No.: 13/724,514

(22) Filed: Dec. 21, 2012

(30) Foreign Application Priority Data
Jan. 10, 2012 (JP) 2012-002385

(51) Int. Cl. G06F 15/167

(52) U.S. Cl. CPC G06F 15/167
USPC 709/213

(57) ABSTRACT

The present invention provides a novel network communications apparatus that includes a LAN interface that transmits and receives data via a network, a plurality of memory resources to transfer data to an application, an analyzing unit that divides data to be sent and received data into a control part and a content part and analyzes the control part, a storage unit that stores rules to determine resources to be used and transfer control method in accordance with characteristic of the data to be sent and the received data, and a controller that transfers the content data to the application in accordance with a result of analyzing the control part of the data to be sent and the received data and applying the rule.

### CROSS-REFERENCE TO RELATED APPLICATION

This patent application is based on and claims priority pursuant to 35 U.S.C. §119 to Japanese Patent Application No. 2012-002385, filed on Jan. 10, 2012 in the Japan Patent Office, the entire disclosure of which is hereby incorporated by reference herein.

### BACKGROUND OF THE INVENTION

1. Field of the Invention

The present invention relates to a network communications apparatus, method, and medium.

2. Description of the Background Art

Conventionally, computer systems embedded in home appliances and machines to implement specified functions (hereinafter referred to as “embedded systems”) can utilize only limited resources to achieve energy saving. It should be noted that “resources” here means memory capacity, processing speed of Central Processing Units (CPUs) etc., and hard disk capacity necessary to have any software and hardware work.

Recently, embedded systems have become multifunctional and are required to deal with a plurality of kinds of data on a network and satisfy stringent performance requirements in real time. A technology of reducing resources by separating a network communication unit from an application unit and sharing network communication units has been proposed (e.g., JP-2004-005503-A.)

The purpose of the technology described in JP-2004-005503-A is to provide a novel image forming/processing apparatus that makes it easier to develop and add applications that provide web services. More particularly, the image forming/processing apparatus is comprised of a plurality of method processing units that execute predefined processes according to a method and a web service executing unit that executes the web service by dividing processing requests among the method processing according to the method specified by the processing request in response to the processing request.

However, in the technology described in JP-2004-005503-A, transfer cannot be controlled by allocating appropriate resources for each different kind of data transmitted and received via a network only by sharing communication units. Therefore, handling multiple different kinds of data in the same manner results in using limited resources in vain, and satisfactory performance cannot be achieved for data that requires high transfer speed and real-time response.

### SUMMARY OF THE INVENTION

The present invention provides a novel network communications apparatus, method, and medium that can improve network communication performance and real-time response in embedded systems.

More specifically, the present invention provides a network communications apparatus that includes a LAN interface that transmits and receives data via a network, a plurality of memory resources to transfer data to an application, an analyzing unit that divides data to be sent and received data into a control part and a content part and analyzes the control part, a storage unit that stores rules to determine a resource to be used and transfer control method in accordance with characteristic of the data to be sent and the received data, and a controller that transfers the content data to the application in accordance with a result of analyzing the control part of the data to be sent and the received data and applying the rule.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating a network communications apparatus as an embodiment of the present invention.

FIG. 2 is a diagram illustrating the network communications apparatus shown in FIG. 1 as an embodiment of the present invention.

FIG. 3 is a sequence diagram illustrating an operation of an image processing apparatus shown in FIG. 2 as an embodiment of the present invention.

FIG. 4 is a diagram illustrating a module and task configuration of the network communications apparatus as an embodiment of the present invention.

FIG. 5 is a diagram illustrating an internal configuration of a TRANS module 203 as an embodiment of the present invention.

FIG. 6 is a flowchart illustrating an operation of the network communications apparatus as an embodiment of the present invention.

FIGS. 7A and 7B are parts of a flowchart illustrating an operation of the network communication unit shown in FIG. 1 as an embodiment of the present invention.

FIGS. 8A, 8B, and 8C are remaining parts of a flowchart illustrating an operation continued from FIGS. 7A and 7B as an embodiment of the present invention.

FIG. 9A is a diagram illustrating a process of sending memory copy of payload part in plain communication, and 9B is a diagram illustrating a process of receiving memory copy of payload part as an embodiment of the present invention.

FIG. 10A is a diagram illustrating a process of sending in encrypted communication, and 10B is a diagram illustrating a process of receiving in encrypted communication as an embodiment of the present invention.

FIG. 11A is a diagram illustrating a process of sending in plain communication, and 11B is a diagram illustrating a process of receiving in plain communication as an embodiment of the present invention.

FIG. 12A is a diagram illustrating a process of sending in encrypted communication, and 12B is a diagram illustrating a process of receiving in encrypted communication as an embodiment of the present invention.

### DETAILED DESCRIPTION OF THE INVENTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

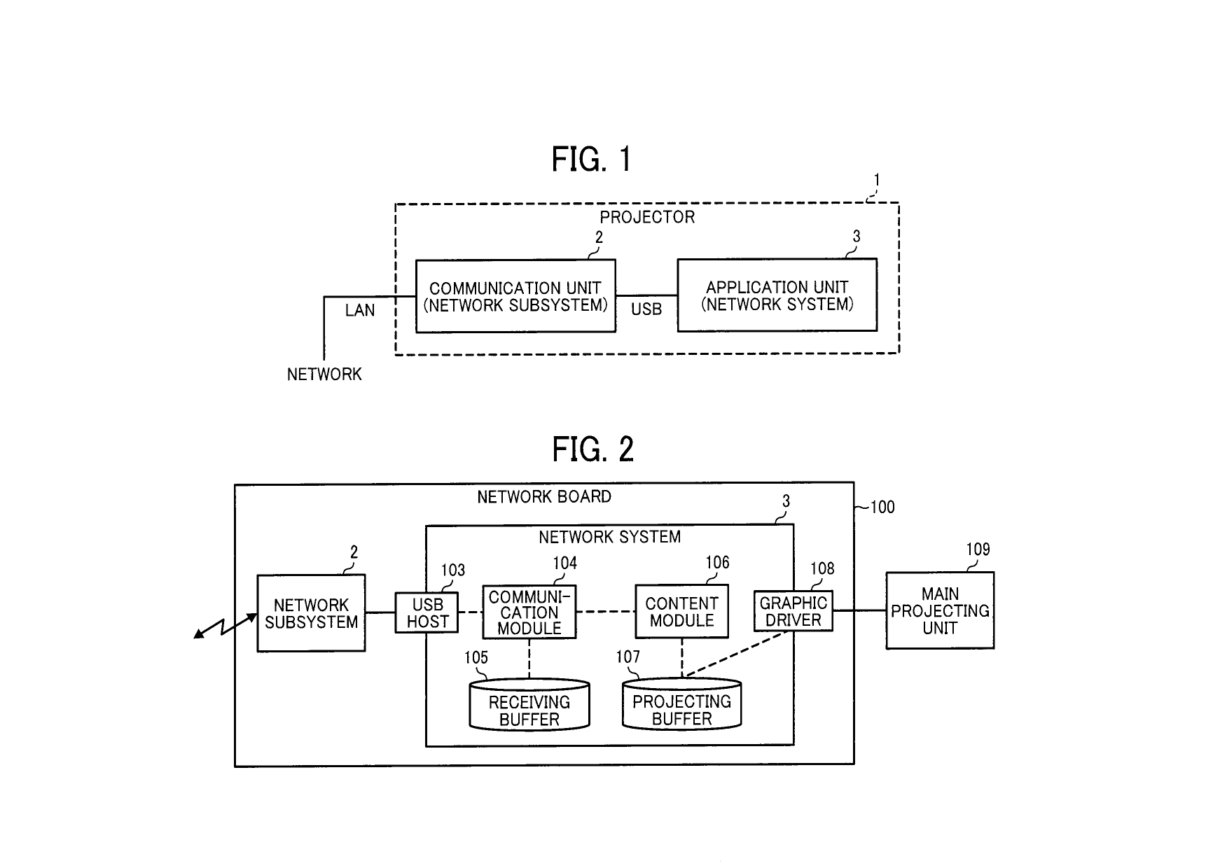

FIG. 1 is a diagram illustrating a network communications apparatus in this embodiment. A projector 1 as a network communications apparatus includes a communication unit 2 connected to a network via a Local Area Network (LAN), and an application unit 3 connected to the communication unit 2 via Universal Serial Bus (USB).

The projector 1 determines a resource to be used and transfer control method based on Table 1A and 1B by analyzing only control part of data received by the communication unit 2 and recognizing characteristic of content data.

Resources to be used as a key point of the network communications apparatus of this invention are described below.

SRAM_DATA is memory used in generic processing operations of the communication unit. SRAM_{—} TOE and SRAM_{—} LAN are memory used to transmit/receive data with a LAN interface. SRAM_WHIO is memory used to transfer data to the application unit 3. In this embodiment, this memory is logically divided into small size (2 KB) and large size (16 KB) spaces.

TABLE 1A

| | | Characteristic of content data | | | |
|---|---|---|---|---|---|
| | | | | | Name of |
| | | | | | sub- |
| | | | | | system that |
| | | | | | includes |
| | Content | Operation | Operation | | operation |
| No. | of data | objective | method | MIME type | objective |
| 1 | Generate | /service/ | POST | application/ | Network |
| | projection job | projection | | json | system |
| | | | | *may not exist | |
| | | | | in some cases | |
| 2 | Projected data | /service/ | PUT | image/jpeg | Network |
| | (still images) | projection | | | system |
| 3 | Projected data | /service/ | PUT | video/ | Network |
| | (PC screens) | projection | | x-rncb | system |
| 4 | Update | /service/ | PUT | application/ | Network |
| | projection job | projection | | json | system |
| 5 | Acquire status | /service/ | GET | application/ | Network |
| | of projection job | projection | | json | system |
| 6 | Delete | /service/ | GET | application/ | Network |
| | projection job | projection | | json | system |
| 7 | Acquire | /state | GET | application | Network |
| | device status | | | /json | sub-system |
| 8 | Change device | /state | PUT | application/ | Network |
| | status | | | json | sub-system |
| 9 | Acquire device | /property | GET | application/ | Network |
| | information | | | json | sub-system |
| 10 | Change device | /property | PUT | application/ | Network |
| | information | | | json | sub-system |

TABLE 1B

| | | Resource to be used and transfer control method | | | |
|---|---|---|---|---|---|
| | | Is control | | | |
| | | information | | | |
| | | included in | | | Pattern |
| | Content | transferred | Buffer to be | | of data |
| No. | of data | data? | used | Transfer unit | flow |
| 1 | Generate | Yes | SRAM_WHIO | Buffer size | PA |
| | projection | | (small size) | or actual | |
| | job | | | data size | |
| 2 | Projected data | Yes | SRAM_WHIO | Buffer size | PA |
| | (still images) | | (large size) | or actual | |
| | | | | data size | |
| 3 | Projected data | Yes | SRAM_WHIO | Chunk size | PA |
| | (PC screens) | | (large size) | (in units of | |
| | | | | divided data | |
| | | | | specified by | |
| | | | | commu- | |
| | | | | nication | |
| | | | | party) | |
| 4 | Update | Yes | SRAM_WHIO | Buffer size | PA |
| | projection | | (small size) | or actual | |
| | job | | | data size | |
| 5 | Acquire status | Yes | SRAM_WHIO | Buffer size | PA |
| | of projection | | (small size) | or actual | |
| | job | | | data size | |
| 6 | Delete | Yes | SRAM_WHIO | Buffer size | PA |
| | projection | | (small size) | or actual | |
| | job | | | data size | |
| 7 | Acquire | No | SRAM_DATA | Buffer size | PB |
| | device status | | | or actual | |
| | | | | data size | |
| 8 | Change | No | SRAM_DATA | Buffer size | PB |
| | device status | | | or actual | |
| | | | | data size | |
| 9 | Acquire device | No | SRAM_DATA | Buffer size | PB |
| | information | | | or actual | |
| | | | | data size | |
| 10 | Change device | No | SRAM_DATA | Buffer size | PB |
| | information | | | or actual | |
| | | | | data size | |

Table 1A and 1B illustrate characteristics of content data, resource to be used, and transfer control methods. Operation objectives, operation methods, MIME types, and names of sub-systems that include operation objectives are listed as characteristics of content data. Whether or not control information is included in transfer data, buffer to be used, and patterns of dataflow are listed as resources to be used and transfer control methods.

In Table 1A, “/service/projection”, “/state”, and “/property” in the operation objective column indicate Uniform Resource Locators (URLs).

Also, in Table 1A and 1B, “still image” indicates a JPEG image, and “PC screen” indicates a moving image.

In Table 1A and 1B, “Acquire status of projection job” indicates a command to acquire status of projection job of a projector. The projector has a function that acquires status of projection job remotely as one of its administrative functions. Specifically, information that indicates that projection job has started and can be interrupted can be acquired.

In Table 1A and 1B, “Acquire device status” indicates a command to acquire device status of the projector. The projector has a function that acquires device status remotely as one of its administrative functions. Specifically, information that indicates device specifications and settings can be acquired.

In Table 1A, “POST”, “PUT”, and “GET” in the operating method column indicate examples of data operating methods. HTTP methods are associated with data operating methods in this embodiment.

In Table 1B, the “large” and “small” that indicate the amount of space in the buffer to be used are purely examples, and they can be divided into smaller sizes. The point is to use appropriate buffer resources in accordance with the content of the data. For example, 16 KB can be used for dealing with projected data in No. 2 and 3. In commands such as No. 1, 4, 5, and 6, more processes can be executed concurrently by using 2 KB size of buffer. If 16 KB buffer is used for all cases, less processing can be executed concurrently due to memory limitation.

“Generate projection job”, “projected data (still images and PC screens)”, “update projection job”, “acquire status of projection job”, “delete projection job”, “acquire device status”, “change device status”, “acquire device information”, and “change device information” are listed as content of data. It should be noted that data flow patterns will be described later.

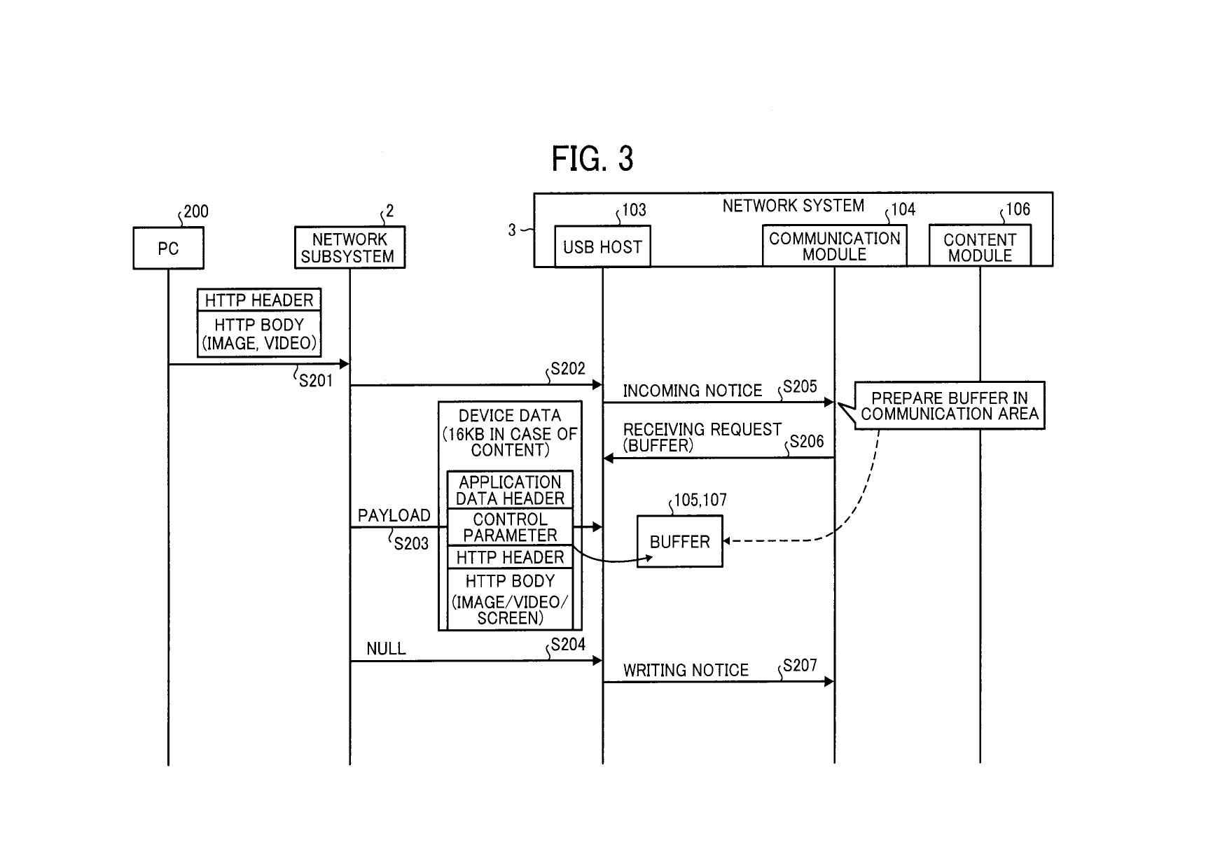

FIG. 2 is a diagram illustrating the network communications apparatus shown in FIG. 1. A network communications apparatus shown in FIG. 2 includes a network board 100 and a main projecting unit 109. The network board 100 includes a network sub-system 2 and a network system 3. The network sub-system 2 is hardware that executes protocol control and packet control, and partly analyzes received data. The network sub-system 2 operates as a USB device and transfers data to the network system 3. The network system 3 is hardware that has a communication module 104, a content module 106, a USB host 103, and a graphic driver 108 operate. The communication module 104 is software that analyzes received data in detail and operates application software that corresponds to content of the data. The communication module 104 utilizes other modules if necessary in having application software operate. The content module 106 is software that outputs image data written in a projecting buffer 106 (content data) by using the graphic driver 108. The USB host 103 is software that controls USB devices. The graphic driver 108 is software that controls graphic devices. The main projecting unit 109 is a graphic device that projects image data as a visible image of light. A personal computer 200 (PC, not shown in figures) is connected to the network sub-system 2.

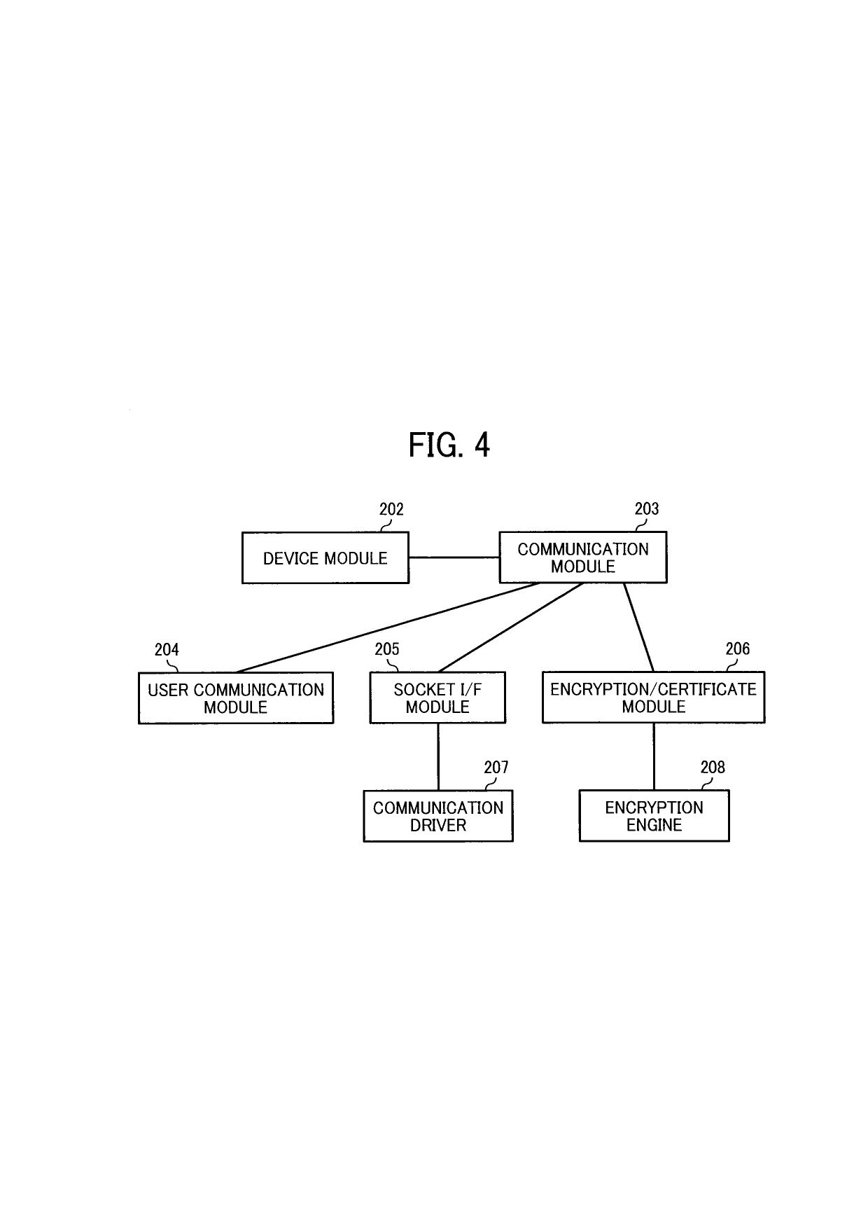

FIG. 3 is a sequence diagram illustrating an operation of the image processing apparatus shown in FIG. 2. After the PC 200 sends data (received data) that includes a Hyper Text Transfer Protocol (HTTP) header and a HTTP body (still images and moving images) in S201, the network sub-system 2 sends the received data, payload (device data), and NULL to the USB host 103 in the network system 3 (S202, S203, and S204). The USB host 103 notifies the communication module 104 in the network system 3 of receiving the data (S205). The communication module 104 in the network system 3 prepares for buffer in communication area and notifies the USB host 103 of that (S206). The USB host 103 writes the header and the body, etc., of the device data to the prepared buffer 105 and 107 and notifies the communication module 104 of writing the data (S207).

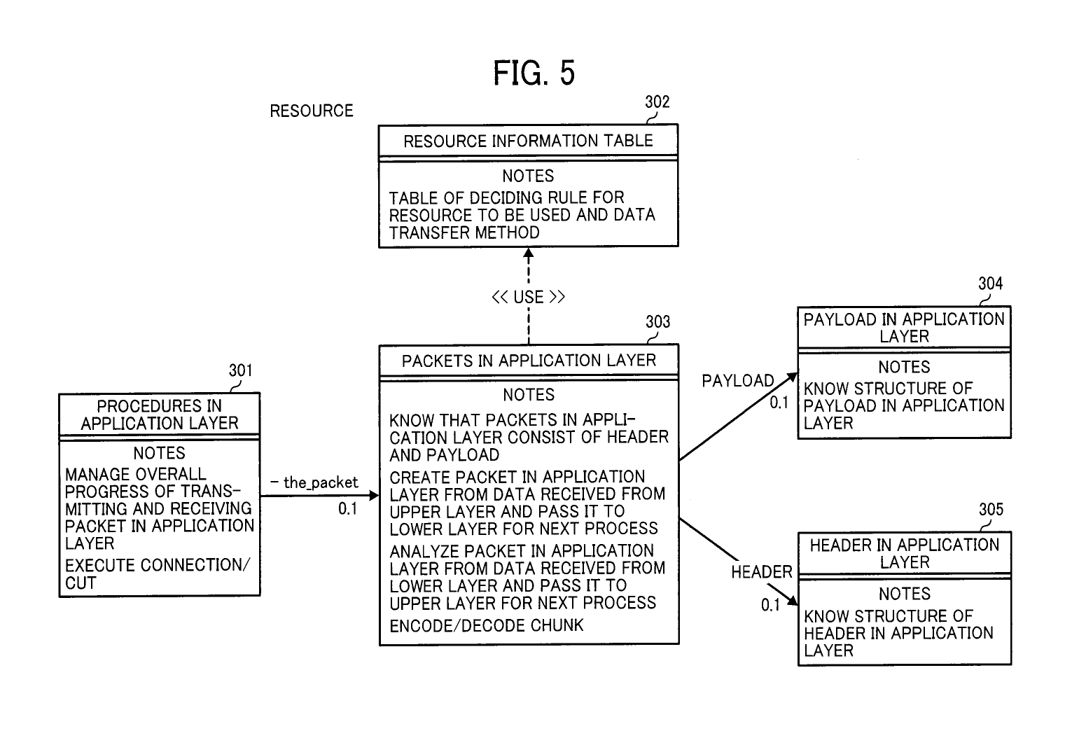

FIG. 4 is a diagram illustrating a module and task configuration of the network communications apparatus in this embodiment. The network communications apparatus includes a device module 202, a communication module 203, a USER communication module 204, a Socket I/F module 205, an encryption/certificate module 206, a communication driver 207, and an encrypting engine 208. It should be noted that a “task” is a unit of executing process from the viewpoint of an Operating System (OS). While “thread” is usually regarded as a unit of execution, some OS regards process (a whole part of program that includes a plurality of threads) as a unit of execution.

Among these modules, the USER communication module 204 depends on the device module 202, and the encryption/certificate module 206 and the device module 202 are mutually dependent. The communication module 203 and the device module 202 are mutually dependent, and the Socket I/F module 205, the USER communication module 204, and the encryption/certificate module 206 depend on the communication module 203. The communication driver 207 depends on the Socket I/F 205, and the encrypting engine 208 depends on the encryption/certificate module 206.

Next, responsibilities of each module are described below with reference to Table 2 and Table 3.

TABLE 2

| Module | | |
|---|---|---|
| name | Code | Outline of feature |
| Starting up | START | Initialize hardware and software on start-up and start tasks. |
| module | | Have following functions to provide network communication |
| | | function to network system. |
| | | (1) Receive request for sending TCP/UDP from network system |
| | | via [USER], and transfer data to network by using [SOCK] |
| | | (2) Receive notification for receiving network data from |
| | | [SOCK], and transfer received data to network system by using |
| | | [USER] |
| | | (3)Transfer data between SRAM_DATA and SRAM_ToE/ |
| | | SRAM_LAN and between SRAM_WHIO and SRAM_ToE/ |
| | | SRAM_LAN. |
| Communication | TRANS | * Implement network communication function that network |
| area module | | sub-system executes autonomously in case of normal |
| | | operation mode and energy saving mode of network system. |
| | | * Implement SSL protocol function and IEEE 802.1x |
| | | protocol function. |
| | | * Manage buffer on SRAM_DATA and SRAM_SEC. |
| | | * Implement user authenticating function executed on |
| | | protocol. |
| | | * Setting tasks 1-2. |
| | | * Transmitting/Receiving task of TCP sockets 1 to 6. |
| | | * Transmitting/Receiving task of raw sockets 1 to 2. |
| Supplicant | SUPP | Execute connection on layer 2 level (including security). |
| module | | * Supplicant task |
| | | * WPS, WPA supplicant |
| | | (a) Control connect/ cut wireless LAN |
| | | (b) Sharewireless LAN communication and key updating |
| | | communication based on WPA specification |
| | | * Wireless LAN easy-setup communication based on WPS |
| | | specification |
| | | * Ad-hoc one-on-one easy connecting communication |
| | | * Store device specific information received from |
| | | network system via [USER] to flash memory, and |
| | | provide device specific information on demand from network |
| | | system or [TRANS]. |
| | | Write firmware updating data received from network system |
| | | via [USER] to flash memory. |
| | | * Control status of network system. Control power domain |
| | | of network sub-system and power supply of network |
| | | system in accordance with request for transition to/from |
| | | energy saving mode. Also, control network systeand |
| | | PIC in accordance with energy saving mode control signal |
| | | received via GPIO. |
| Device module | INFO | Turn wireless LAN on/off and reconfigure wireless LAN. |
| | | * Provide permanent data stored in flash memory onetwork |
| | | sub-system to Also, execute request foreading/writing |
| | | data received from network system via [USER], and return |
| | | read value to network system via [USER]. |
| | | Provide functions of managing data (including measure |
| | | for power-off of flash) and controlling energy saving. |
| | | * Accept error status of network sub-system from each |
| | | module, notify a user of error information, and output |
| | | the error information for debugging. |
| | | * INFO task |
| USER | USER | Implement following functions for controlling communication |
| communication | | with [network system] via USB. |
| module | | (1) Notify appropriate upper module of receiving data |
| | | by referring to header part of data received from network |
| | | system via USB. |
| | | (2) Control USB macro to send data prepared on |
| | | SRAM_ToE, SRAM_LAN, and SRAM_SEC to network |
| | | system in accordance with request from upper module. |
| | | Manage buffer on SRAM_WHIO. |
| Socket I/F | SOCK | * Implement following functions to provide network |
| module | | function for [TRANS]. |
| | | (1) Provide socket-like I/F for upper module. |
| | | (2) Manage buffer on SRAM_LAN, SRAM_ToE, and |
| | | SRAM_SEC. |
| | | * Control ToE for network communication |
| | | * Control MAC |

TABLE 3

| Module name | Code | Outline of feature |
|---|---|---|
| CRYPTO | CRYPTO | Process certificate |
| module | | * KPCS#12 |
| | | * CERTLIB (X.509 format etc.) |
| | | Encrypt auxiliary module (random number, common key, |
| | | and public key) that provides encryption processing |
| | | function for upper level by using encryption hardware. |
| Debug monitor | DEBUG | Provide debug outputting function to UART |
| MAC driver | MAC | Driver of MAC macro |
| WLAN | WLAN | Control WLAN macro and frame converter |
| driver | | Manage WLAN buffer on SRAM_SEC and data buffer |
| | | used by WLAN on SRAM_LAN. |
| | | Control WLAN module via PCIe ROOT. Include PCIe |
| | | driver. |
| | | * WLAN task |
| XDMAC | XDMAC | Driver of XDMAC 1 and 2 macro |
| driver | | XDMAC 1 is XDMAC of WCPU block. XDMAC 2 is |
| | | XDMAC of WSECURITY block. Use XDMAC 1 for |
| | | copying from SRAM_DATA to SRAM_ToE, |
| | | SRAM_LAN, and SRAM_SEC. Use XDMAC2 for |
| | | copying from SRAM_WHIO to SRAM_ToE, |
| | | SRAM_LAN, and SRAM_SEC. |
| EIP122 driver | EIP122 | Driver of EIP122 macro |
| EIP94 driver | EIP94 | Driver of EIP94 macro |
| EIP150 driver | EIP150 | Driver of EIP150 macro |
| UART driver | UART | Driver of UART macro |
| RTC driver | RTC | Driver of RTC macro |
| Watchdog | WDT | Driver of Watchdog timer. WatchdogOUT issues |
| timer | | full reset function of network sub-system |
| driver | | |
| GPIO/EXIU | GPIO | Driver of GPIO/EXIU macro |
| driver | | |
| FLASH driver | FLASH | Driver for writing to and erasing flash memory |

Next, rules on transfer of data between the communication unit and the application unit are described below with reference to TABLE 4A and TABLE 4B.

TABLE 4A

| | | Characteristic of content data | | | |
|---|---|---|---|---|---|
| | | | | | Name of sub- |
| | | | | | system that |
| | | Operation | Operation | | includes operation |
| No. | Content of data | objective | method | MIME type | objective |
| 1 | Generate projection | /service/ | POST | application/json | Network system |
| | job | projection | | *may not exist | |
| | | | | in some cases | |
| 2 | Projected data | /service/ | PUT | image/jpeg | Network system |
| | (still images) | projection | | | |
| 3 | Projected data (PC | /service/ | PUT | video/x-rncb | Network system |
| | screens) | projection | | | |
| 4 | Update projection | /service/ | PUT | application/json | Network system |
| | job | projection | | | |
| 5 | Acquire status of | /service/ | GET | application/json | Network system |
| | projection job | projection | | | |
| 6 | Delete projection | /service/ | GET | application/json | Network system |
| | job | projection | | | |
| 7 | Acquire device | /state | GET | application/json | Network sub- |
| | status | | | | system |
| 8 | Change device | /state | PUT | application/json | Network sub- |
| | status | | | | system |
| 9 | Acquire device | /property | GET | application/json | Network sub- |
| | information | | | | system |
| 10 | Change device | /property | PUT | application/json | Network sub- |
| | information | | | | system |

TABLE 4B

| | | Resource to be used and transfer control method | | | |
|---|---|---|---|---|---|
| | | Is control | | | |
| | | infor- | | | |
| | | mation | | | |
| | | included | | | |
| | | in trans- | | | Pattern |
| | Content | ferred | Buffer to | | of data |
| No. | of data | data? | be used | Transfer unit | flow |
| 1 | Generate | Yes | SRAM_WHIO | Buffer size or | PA |
| | projection job | | (small size) | actual data | |
| | | | | size | |
| 2 | Projected data | Yes | SRAM_WHIO | Buffer size or | PA |
| | (still images) | | (large size) | actual data | |
| | | | | size | |
| 3 | Projected data | Yes | SRAM_WHIO | Chunk size | PA |
| | (PC screens) | | (large size) | (in units of | |
| | | | | divided data | |
| | | | | specified by | |
| | | | | commu- | |
| | | | | nication | |
| | | | | party) | |
| 4 | Update | Yes | SRAM_WHIO | Buffer size or | PA |
| | projection job | | (small size) | actual data size | |
| 5 | Acquire | Yes | SRAM_WHIO | Buffer size or | PA |
| | status of | | (small size) | actual data size | |
| | projection job | | | | |
| 6 | Delete | Yes | SRAM_WHIO | Buffer size or | PA |
| | projection job | | (small size) | actual data size | |
| 7 | Acquire | No | SRAM_DAT | Buffer size or | PB |
| | device status | | A | actual data size | |
| 8 | Change | No | SRAM_DAT | Buffer size or | PB |
| | device status | | A | actual data size | |
| 9 | Acquire device | No | SRAM_DAT | Buffer size or | PB |
| | information | | A | actual data size | |
| 10 | Change device | No | SRAM_DAT | Buffer size or | PB |
| | information | | A | actual data size | |

Table 4A and 4B are rule tables to determine “resource to be used and transfer control method” in data transfer between the communication unit and the application unit. Characteristic of content data in Table 4A can be obtained from header information (control information) of application protocol such as HTTP. For example, operation objective is included in URL in HTTP header, operation method is included in request line in HTTP header, and MIME type is included in attribute in HTTP header. Information registered in “name of sub-system where operation objective exists” is determined by the system configuration, and is used as information to determine which memory is used in data transfer for each transfer destination.

The starting up module 210 initializes hardware and software on start-up and boots each task.

The communication area module 203 includes functions (1) to (3) shown in Table 2 to provide network communication for the network system, and has a network communication function that the network sub-system executes autonomously instead of the network system in normal operation mode and energy saving mode. Also, the communication area module 203 includes SSL protocol/IEEE802.1x protocol function, function for managing buffer on SRAM_DATA and SRAM_SEC, and function for user authentication in protocol.

The supplicant module 204 includes function to execute connecting on layer 2 level (including security).

The device module 202 stores device-specific information received from the network system via [USER] to flash memory, and includes function to provide the device specific information on demand from the network system or [TRANS]. The device module 202 writes data for updating firmware received from the network system via [USER] in flash memory. The device module 202 controls status of the network sub-system.

The USER communication module 208 includes functions (1) and (2) shown in Table 2 to control communication with [network system] via USB, controls ToE for network communication, and controls MAC.

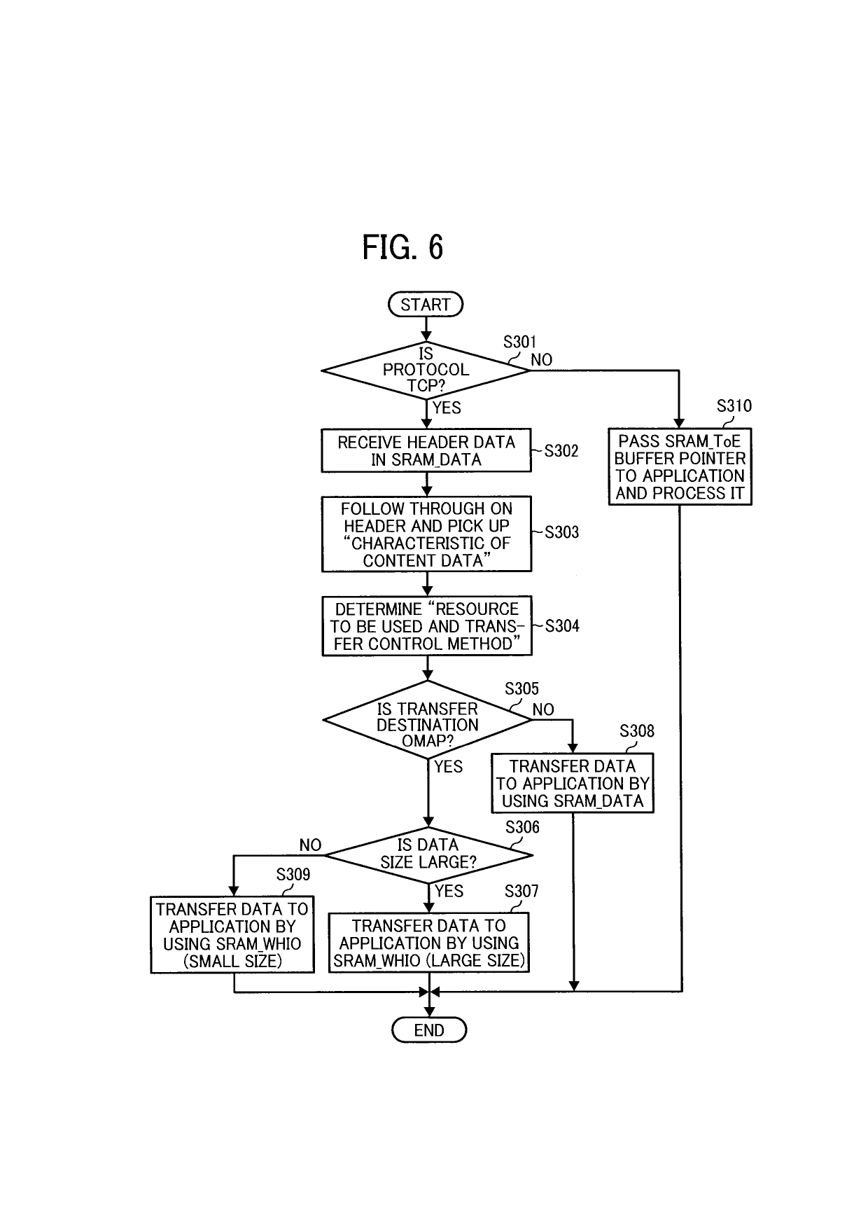

FIG. 5 is a diagram illustrating an internal configuration of a TRANS module 203. Only data transfer is illustrated in FIG. 5. The TRANS module 203 in FIG. 5 includes a procedure in application layer 301, a resource information table 302, a packet in application layer 303, a payload in application layer 304, and a header in application layer 305.

Managing progress of a whole part of transmitting/receiving packet in application layer, connecting and disconnecting are included in the procedures in application layer 301.

The packet in application layer 303 knows that packets in application layer consist of header and payload. Packets in application layer are created from data received from upper layer and is passed to lower layer where following process is executed. Also, packets in application layer are analyzed from data received from lower layer and is passed to upper layer where the following process is executed. Chunk is encoded and decoded.

The resource information table 302 used by the packet in application layer 303 is a table of rules for determining the resource to be used and the data transfer method.

Payload in application layer knows structure of payload in application layer.

Header in application layer knows structure of header in application layer.

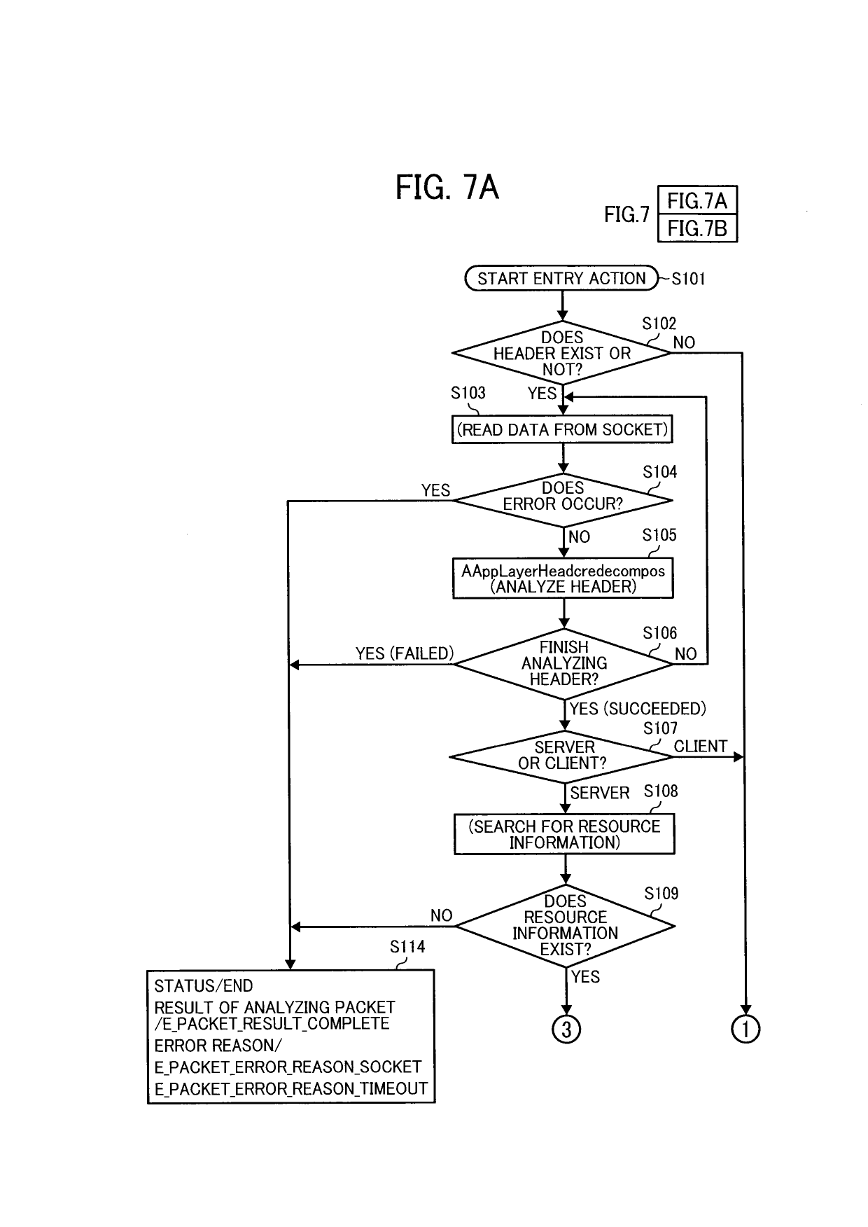

FIG. 6 is an example of a flowchart illustrating an operation of the network communications apparatus. First, it is determined that the transfer protocol is TCP or UDP. (In this embodiment, a different flow is used for UDP protocol since the application unit does not support UDP protocol. In another embodiment, the same flow as TCP protocol can be used.) After only the header part of the protocol is copied to SRAM_DATA and analyzed, resource to be used and transfer control method are determined based on the rule tables (Table 1A, 1B, 2, and 3) from the result of analyzing the header.

Next, whether or not transfer destination to process data is a sub-system (application unit) is determined. If the transfer destination is the application unit, data transfer is executed after determining buffer size to be used in accordance with characteristic of the content data. For example, small size buffer is used if the data content is job generating command, etc., and large size buffer is used for image data to be projected. If content data size is so large that it cannot be processed by data transfer all at once, all data is processed by repeating data transfer to application by using the same type of buffer.

Next, the flowchart shown in FIG. 6 is described in detail below.

The network system 3 is a main body of operation. The network system 3 determines whether or not the protocol is TCP (S301). If the network system 3 determines that the protocol is TCP (YES in S301), header data is received in SRAM_DATA and the process proceeds to S303. If it is determined that protocol is not TCP (NO in S301), OMP3 passes SRAM_ToE buffer pointer to application and finishes after processing the data (S310).

In S303, the network system 3 follows through on the header part, picks up “characteristic of content data”, and determines “resource to be used and transfer controlling apparatus” (S304). The network system 3 determines whether or not transfer destination is the network system 3 (S305). If it is determined that transfer destination is the network system 3 (YES in S305), whether or not data size is larger than a predefined value is determined (S306).

If the network system 3 determines that transfer destination is not the network system 3 (NO in S305), the data is transferred to the application by using SRAM_DATA and the process ends (S308).

If the network system 3 determines that the data size is larger than the predefined value (YES in S306), the data is transferred to the application by using SRAM_WHIO (large size) and the process ends (S307).

If the network system 3 determines that the data size is not larger than the predefined value (NO in S306), the data is transferred to the application by using SRAM_WHIO (small size) and the process ends (S309).

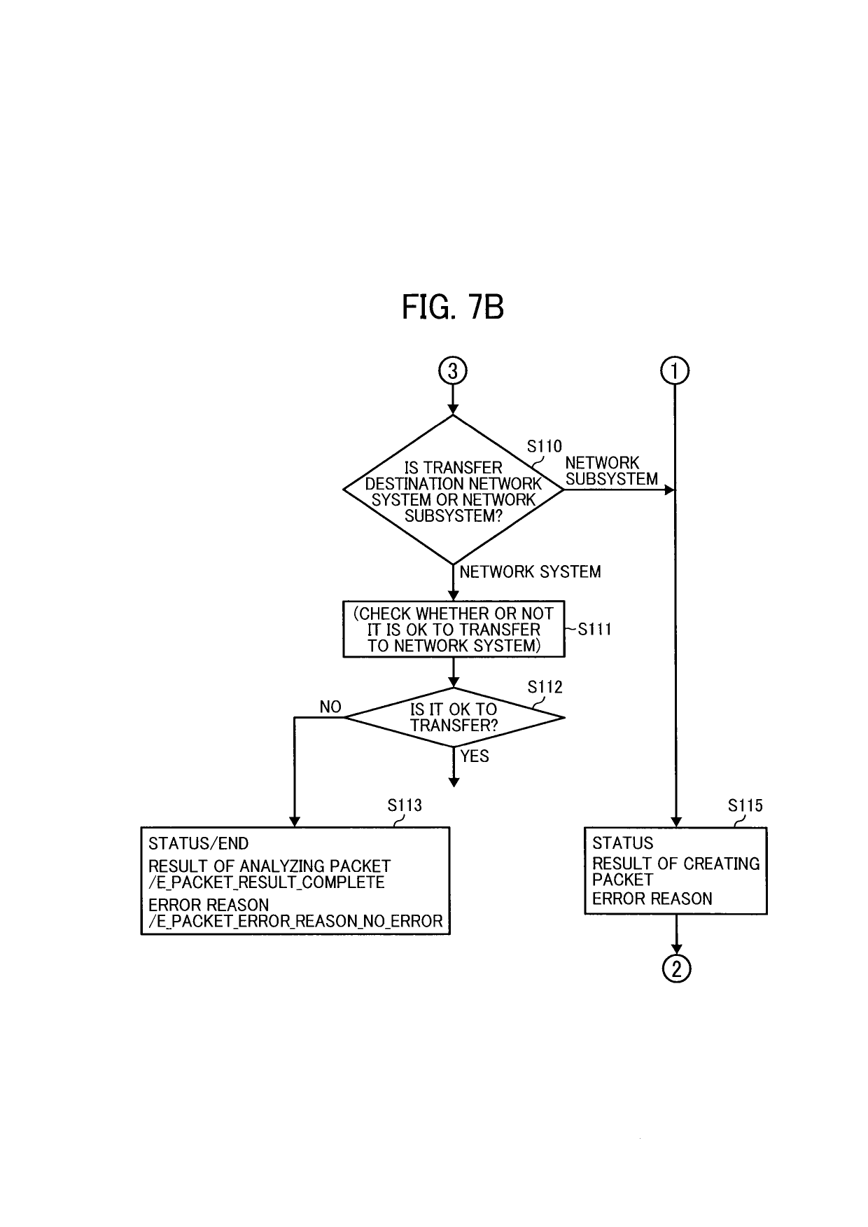

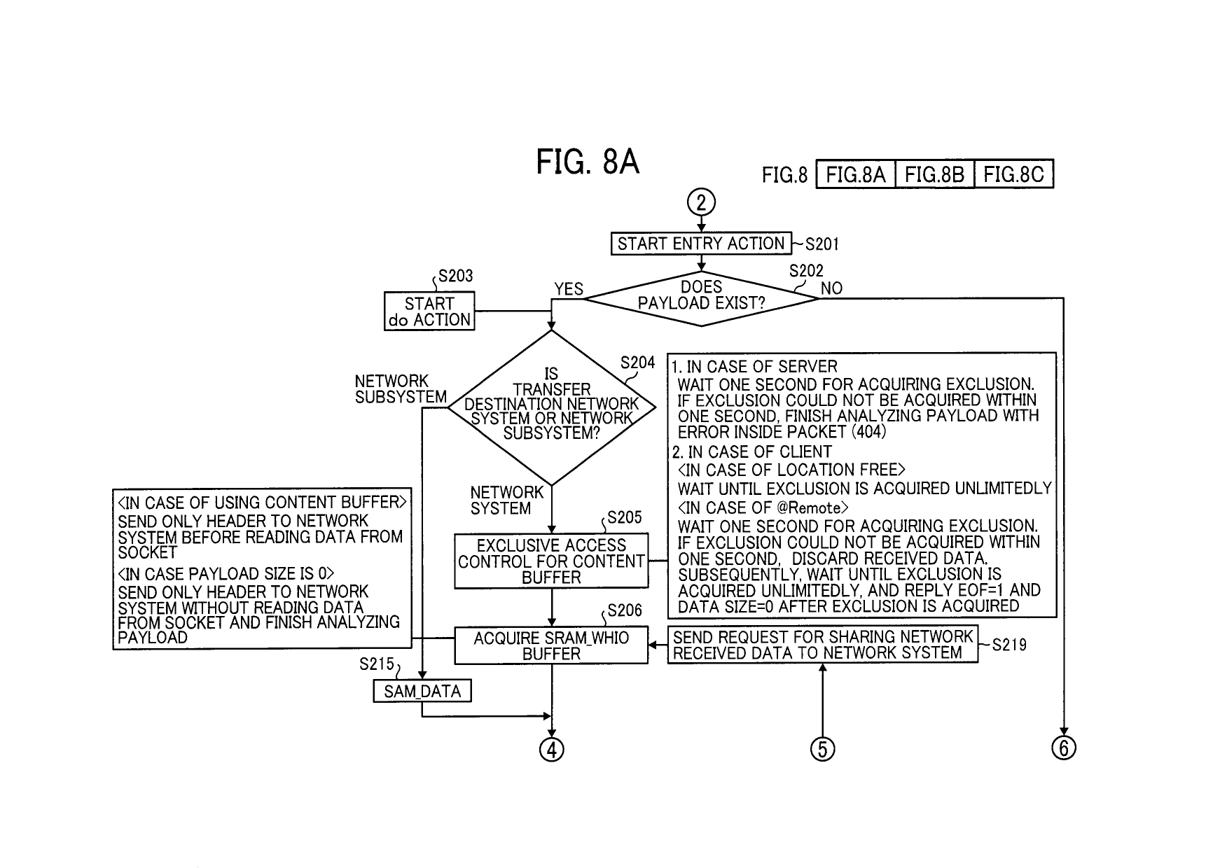

FIGS. 7A and 7B are a flowchart illustrating an operation of the network communication unit shown in FIG. 1, and FIGS. 8A, 8B, and 8C are remaining parts of a flowchart illustrating an operation continued from FIGS. 7A and 7B. The network system 3 is a main body of operation. In FIG. 7A, after the network system 3 starts entry action (S101), the network system 3 determines whether or not a header part exist (S102). If the network system 3 determines that the header part exists, data is read from socket and the process proceeds to S104 (IsocketInterface:readySocket in S108). If the network system 3 determines that the header part does not exist, the process proceeds to encircled 2 after setting status to DECOMPOSING_HEADER, result of creating packet to E_PACKET_RESULT_COMPLETE, and error reason to E_PACKET_ERROR_REASON_NO_ERROR (S115).

If the network system 3 determines that an error occurred (S104), status is set to END, result of creating packet is set to E_PACKET_RESULT_COMPLETE, and error reason is set to E_PACKET_ERROR_REASON_TIMEOUT (S114).

If the network system 3 determines that no error occurred (S104), the network system 3 analyzes the header part (AAppLayerHeadcredecompos in S105 in FIG. 3). After determining whether or not it has finished analyzing the header part (S106), the process proceeds to S114 if it has finished analyzing (failed) (S106), and the process proceeds to S108 if it is still analyzing.

The network system 3 determines whether it is a server or a client (S107) if it has finished analyzing the header part (succeeded) (S106). The process proceeds to S115 if it is a client, and resource information is searched if it is a server (Resource Info Table:get Resource Info in S108).

The network system 3 determines whether or not the resource information exists (109). If it is determined that no resource information exists (S109), the process proceeds to S114. If it is determined that the resource information exists (S109), it is determined whether or not transfer destination is the network system 3 (S110).

If the network system 3 determines that transfer destination is the network sub-system, the process proceeds to S115. If the network system 3 determines that transfer destination is the network system (S110), the network system 3 checks whether or not it is OK to transfer to the network system (INFO CanExecute in S111 and determines whether or not it is OK to transfer (S112).

If the network system 3 determines that it is not OK to transfer (S112), status is set to END, result of creating packet is set to END, and error reason is set to E_PACKET_ERROR_REASON_NO_ERROR (S113). If the network system 3 determines that it is OK to transfer, it executes transferring.

In FIGS. 8A, 8B, and 8C, steps from S201 to S208, from S210 to S214, from S216 to S220, and S223 are executed only if the content buffer is used.

After starting entry action in S201 in FIG. 8A, the network system 3 determines whether or not payload part exists. If it is determined that no payload part exist (S202), status is set to END, result of creating packet is set to E_PACKET_RESULT_COMPLETE, and error reason is set to E_PACKET_ERROR_REASON_NO_ERROR in S214.

If the network system 3 determines that the payload part exists (S202), the network system 3 determines whether or not transfer destination is the network system 3 (S204). If the network system 3 determines that transfer destination is the network system (S204), it executes exclusive access control of the content buffer (twai sxm (SEM_TRANS_CNTLT_EX) in S205).

In this case, if it is the server, it waits one second, for example, until exclusive access control is achieved. If exclusive access control is not achieved within one second, it is regarded that there is an error inside packet (404) and it is the end of the payload part.

If it is the client and location free, it waits unlimitedly until exclusive access control is achieved. If it is the client and @Remote, it waits one second, for example, until exclusive access control is achieved. If exclusive access control is not achieved within one second, received data is discarded. After that, it waits unlimitedly until exclusive access control is achieved, and it sends a response of EOL=1 and data size=0 at the time of achieving exclusive access control.

If the network system 3 determines that the transfer destination of the payload is the network sub-system (S204), the network system 3 reads SAM DATA (S215) and data from socket (S207).

After acquiring SRAM_WHIO buffer (S206), the network system 3 reads data from the socket described above in S207, and determines whether or not error occurs (S208).

In this case, if the content buffer is used, only the header part is sent to the network system 3 before reading data from the socket. Otherwise, if the payload size is 0, only the header part is sent to the network system 3 without reading data from the socket, and it finishes analyzing the payload part.

If the network system 3 determines that an error occurred (S208), a request for sharing network received data is sent to the network system 3 (S216), and the process proceeds to S217.

In this case, even if USER DhBulStar DhcomBulStart dhComBulStart has never been executed, it is sure to send a request for sharing network received data of EOF/I in order to release buffer space allocated in USER GelDhBul/USER GetComDhBuf.

If the network system 3 determines that no error occurred (S208), the network system 3 releases the payload part (AppLayerPayload::decompose in S209) and determines whether or not it has finished analyzing the payload part (S210). If the network system 3 determines that it has not finished analyzing (S210), it is determined whether or not transfer destination is the network system 3 (S223).

If the network system 3 determines that transfer destination is not the network system 3 but the network sub-system (S223), the process returns to S207. If the network system 3 determines that transfer destination is the network system 3 (S223), the network system 3 determines whether or not buffer of SRAM_WHIO is full (S220).

If the network system 3 determines that buffer of SRAM_WHIO is not full, the process returns to S207. If the network system 3 determines that buffer of SRAM_WHIO is full, a request for sharing network received data is sent to the network system 3 (USER DhBusStart/USER DhComBufStrat in S219), and the process returns to S206.

After determining that analyzing the payload part is finished in S210, the network system 3 determines whether or not transfer destination is the network system 3 (S211). If it is determined that transfer destination is the network system 3 (S211), the network system 3 sends request for sharing network received data (USER DhBufStart/USER DhComBufstart in S212) to the network system 3.

The network system 3 releases exclusive access control of the content buffer (sig sem(SEM_TRANS_CNTNT_EX) in S213). Subsequently, status is set to END, result of creating packet is set to E_PACKET_RESULT_COMPLETE, and error reason is set to E_PACKET_ERROR_REASON_NO_ERROR in S214.

If the network system 3 determines that transfer destination is the network sub-system 3 in S211, the process proceeds to S214.

If the network system 3 determines that no payload part exists in S202, the process proceeds to S214.

Data Flow Patterns

There are three patterns of copying memory in data transfer, described below.

(PA) TCP Data Transfer that Needs to Transfer to the Network System e.g., HTTP(S) Server and HTTP(S) Client

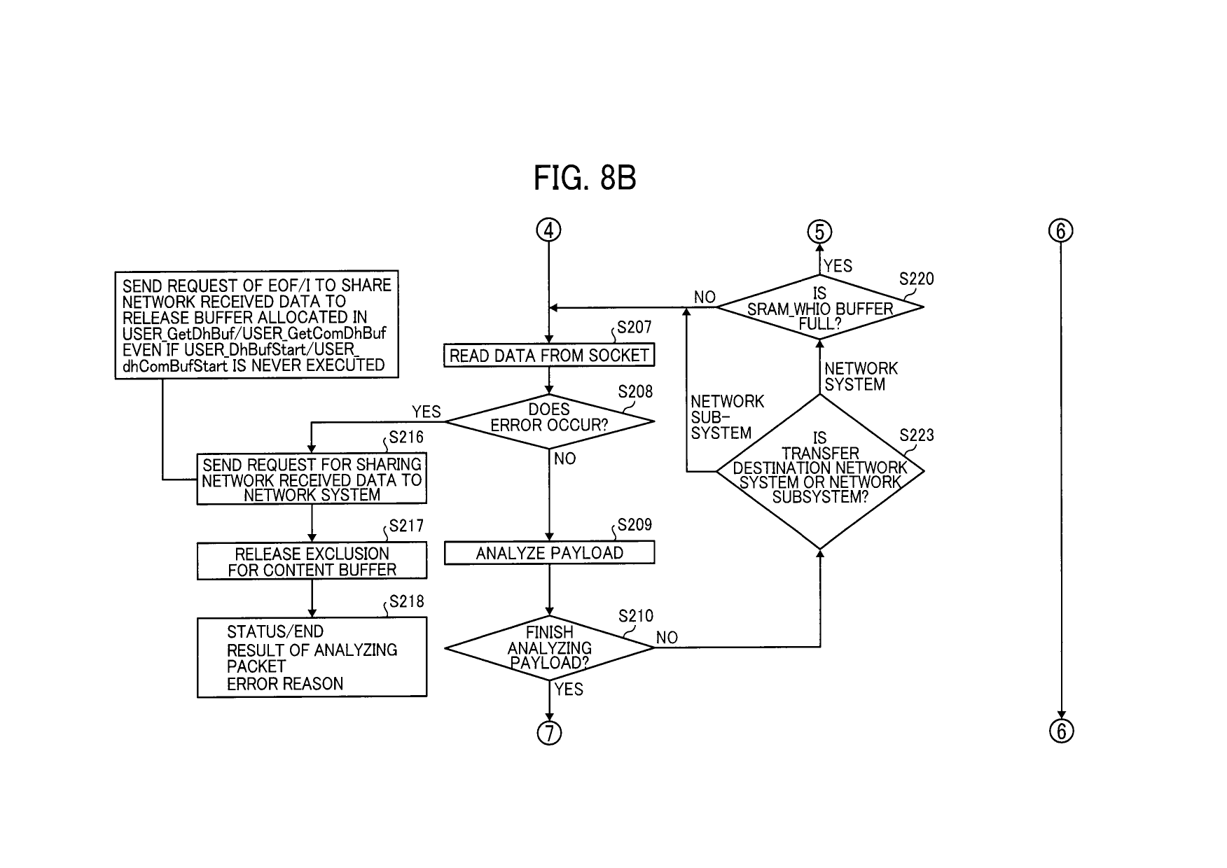

In case of plain communication, FIG. 9A is a diagram illustrating a process of sending memory copy of payload part in plain communication, and FIG. 9B is a diagram illustrating a process of receiving memory copy of payload part. As shown in FIGS. 9A and 9B, the TRANS module copies only the header part from SRAM_WHIO to SRAM_DATA, and copies the header part copied to SRAM_DATA and the payload part remaining in SRAM_WHIO to SRAM_LAN. The reason to copy the header part to SRAM_DATA is that it is necessary to execute process for adding the header part in the network sub-system side. Copying memory for the header part takes place twice, and copying memory for the payload part takes place once.

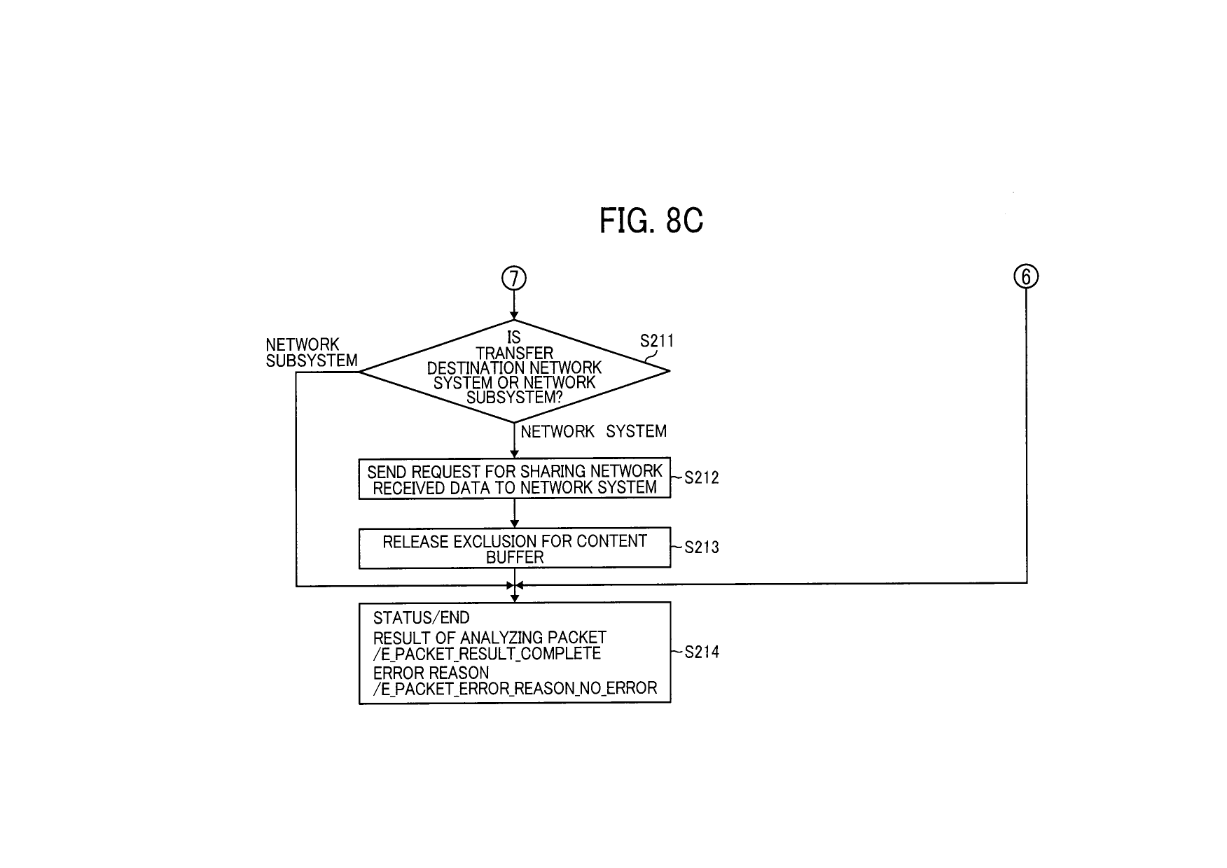

In case of encrypted communication, FIG. 10A is a diagram illustrating a process of sending in encrypted communication, and FIG. 10B is a diagram illustrating a process of receiving in encrypted communication. As shown in FIGS. 10A and 10B, the TRANS module copies both the header part and the payload part to SRAM_SEC (IN DATA) as input data for encrypt conversion. After encrypting, SRAM_SEC (OUT_DATA) as output data for encrypt conversion is copied to SRAM_LAN. Copying memory takes place three times.

(PB) TCP Data Transfer that Closes in the Network System

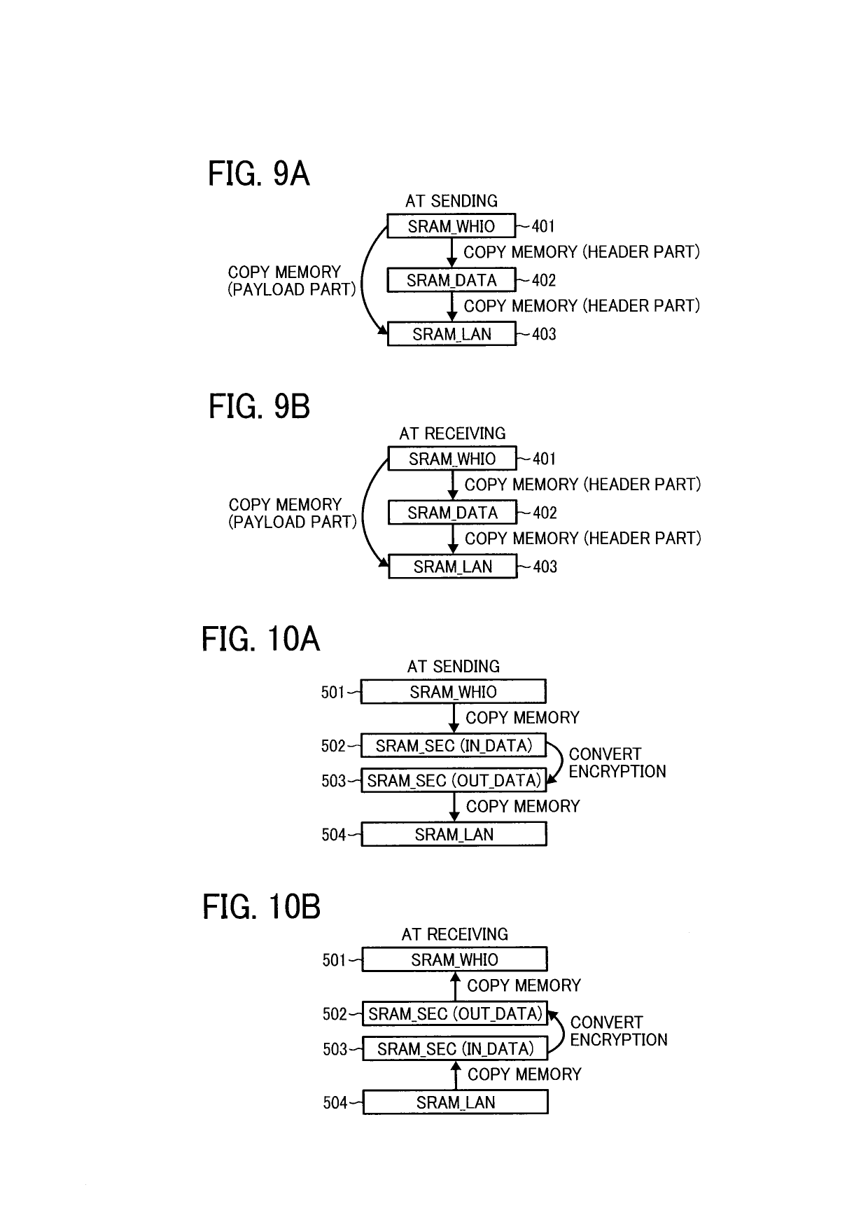

FIG. 11A is a diagram illustrating a process of sending in plain communication, and FIG. 11B is a diagram illustrating a process of receiving in plain communication.

In case of plain communication, as shown in FIGS. 11A and 11B, the TRANS module reads data to be sent and writes received data from/to SRAM_DATA, and copies from SRAM_DATA to SRAM_LAN by using the SOCK module once. Copying memory is necessary once in order to hide operation of ring buffer for TCP in SOCK module.

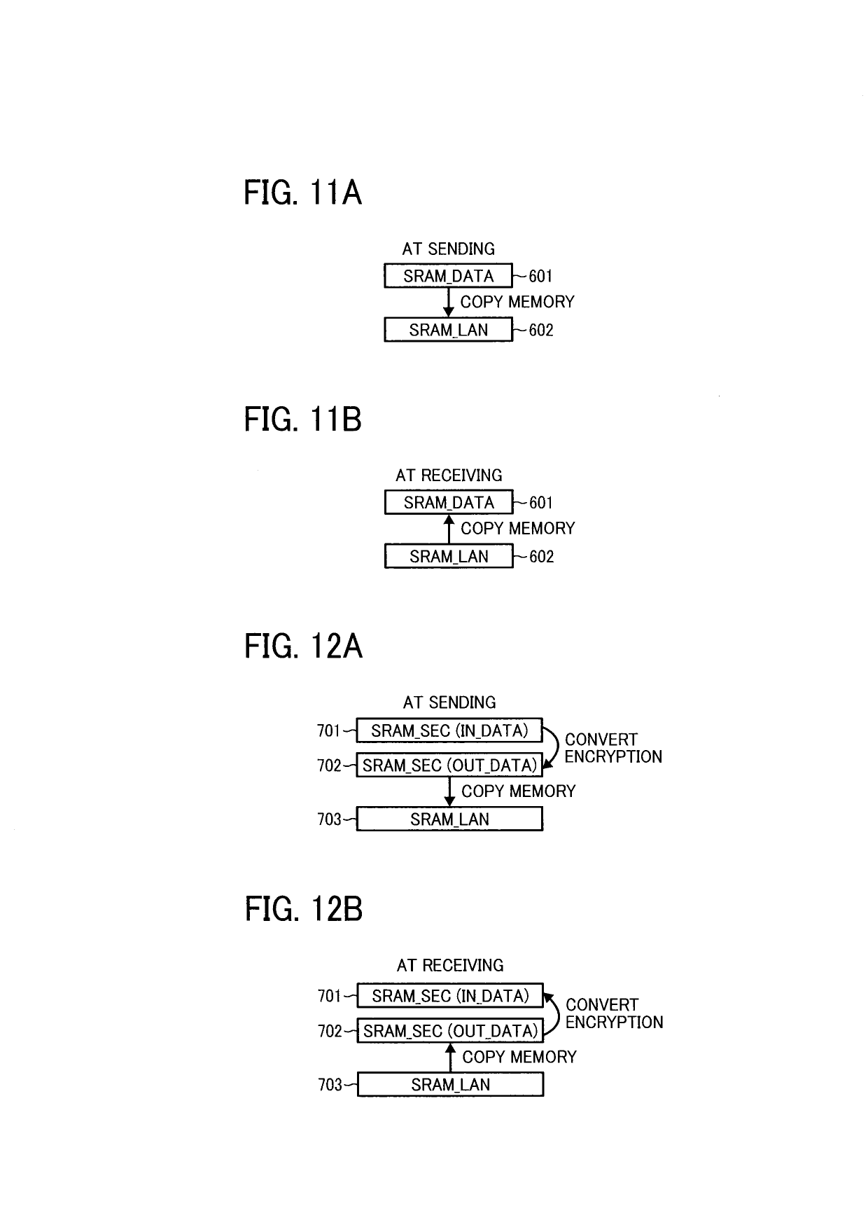

In case of encrypted communication, FIG. 12A is a diagram illustrating a process of sending in encrypted communication, and FIG. 12B is a diagram illustrating a process of receiving in encrypted communication.

As shown in FIGS. 12A and 12B, the TRANS module reads data to be sent and writes received data from/to SRAM_SEC (IN_DATA) as input data for encrypt conversion, and copies SRAM_SEC (OUT_DATA) to SRAM_LAN as output data for encrypt conversion. Copying memory takes place twice.

(PC) UDP Data Transfer that Closes in the Network Sub-System

The TRANS module reads data to be sent and writes received data from/to SRAM_ToE directly, and no memory copy is executed.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. A network communications apparatus, comprising:
a LAN interface to transmit and receive data via a network;
a plurality of memory resources to transfer data to an application;
an analyzing unit to divide data to be sent and received data into a control part and a content part and to analyze the control part;
a storage unit to store a rule table of rules to determine a memory resource to be used and transfer control method in accordance with characteristics of the data to be sent and the received data; and
a controller to transfer content data to the application in accordance with a result of analyzing the control part of the data to be sent and the received data and applying the rules.

2. The network communications apparatus according to claim 1, wherein the controller divides a memory resource determined by applying the rules into a plurality of buffers and uses the buffers.

3. The network communications apparatus according to claim 1, wherein the controller analyzes the control part of the data to be sent and the received data and occupies the memory resources in case a plurality of memory resources that can be used are determined to exist after applying the rules.

4. The network communications apparatus according to claim 1, wherein the controller transfers control information before transferring the content data to the application.

5. The network communications apparatus according to claim 1, wherein the controller associates units of transfer data to the application with transfer units of a communication protocol.

6. The network communications apparatus according to claim 1, wherein the controller determines the memory resource to be used and the transfer control method by checking a protocol type in addition to the characteristics of the content data.

7. The network communications apparatus according to claim 1, wherein the controller checks whether or not the application is ready to process before data transfer to the application.

8. The network communications apparatus according to claim 1, wherein the controller configures the rule table dynamically by receiving characteristic of the content data from the application.

9. A method of communicating via a network, comprising the steps of:
transmitting and receiving data via a network;
transferring data to an application;
dividing data to be sent and received data into a control part and a content part and analyzing the control part;
storing rules to determine a resource to be used and transfer control method in accordance with characteristic of the data to be sent and the received data; and
transferring content data to the application in accordance with a result of analyzing the control part of the data to be sent and the received data and applying the rule.

10. A non-transitory computer-readable medium storing a program that, when executed by a computer, causes the computer to implement a method of communicating via a network,
the method comprising the steps of:
transmitting and receiving data via a network;
transferring data to an application;
dividing data to be sent and received data into a control part and a content part and analyzing the control part;
storing rules to determine a resource to be used and transfer control method in accordance with characteristic of the data to be sent and the received data; and
transferring content data to the application in accordance with a result of analyzing the control part of the data to be sent and the received data and applying the rule.
